(19) United States
(12) Patent Application Publication
(10) Pub. No.: US 2021/0080767 A1
(43) Pub. Date: Mar. 18, 2021

(54) LIQUID CRYSTAL DISPLAY DEVICE

(71) Applicant: Shenzhen China Star Optoelectronics Technology Co., Ltd., Shenzhen (CN)

(72) Inventors: Bingjei Liao, Shenzhen (CN); Yuhua Chang, Shenzhen (CN); Anle Hu, Shenzhen (CN)

(73) Assignee: Shenzhen China Star Optoelectronics Technology Co., Ltd., Shenzhen (CN)

(21) Appl. No.: 16/308,477

(22) PCT Filed: Sep. 13, 2018
(86) PCT No.: PCT/CN2018/105593

§ 371 Date: Dec. 9, 2018

(30) Foreign Application Priority Data
May 3, 2018 (CN) 201810416740.1

(51) Int. Cl. G02F 1/1347; G02F 1/1368; G02F 1/1335; G09G 3/36; G09G 3/34

(52) U.S. Cl. CPC G02F 1/1347; G02F 1/1368; G02F 1/133528; G09G 2320/0626; G09G 3/3648; G09G 3/3426; G09G 2340/0407; G02F 1/133514

(57) ABSTRACT

The present invention teaches a LCD device, including a backlight module, a first LCD panel disposed on top of the backlight module, and a second LCD panel disposed on top of the first LCD panel. The first LCD panel divides the light from the backlight module into n×m partitions, where n×m is the first LCD panel. Therefore the number of backlight partitions is significantly increased. The first LCD panel does not have a CF substrate, and therefore the first LCD panel functions like a monoc screen, controlling the transmittance of each partition and providing to the backlight partition by partition. The backlight, after being adjusted partition-wise by the first LCD panel, is then incident into the second LCD panel for color display, thereby achieving better contrast, improved display effect, and enhanced display quality.

### FIELD OF THE INVENTION

The present invention is generally related to the field of display technology, and more particularly to a liquid crystal display (LCD) device.

### BACKGROUND OF THE INVENTION

Liquid crystal display (LCD) devices are widely applied to TVs, mobile phones, personal digital assistants (PDAs), digital cameras, computer screens, and notebook screens, due to their thin thickness, high quality, power saving, and low radiation.

As shown in FIG. 1, currently most commercially available LCD devices are back-lighted LCD devices, which include a backlight module 100 and a LCD panel 200 on top of the backlight module 100.

As shown in FIG. 2, existing LCD panel usually include a color filter (CF) substrate 201, a thin film transistor (TFT) array substrate 202, and a liquid crystal layer 203 disposed between the two substrates. Combining FIGS. 1 and 2, existing LCD devices are operate by applying driving voltages to control the alignment of the liquid crystal molecules in the liquid crystal layer to refract the light from the backlight module, and producing color pictures as the light go through the CF substrate.

In recent year, LCD devices progress towards greater dimensions and greater resolutions such as from earlier high definition (HD), full HD (FHD), to the current mainstream ultra-high definition (UD) resolution, i.e. the so-called 4K2K (3840×2160). A major issue for the manufacturers is how to differentiate their products.

Currently, most vertical alignment (VA), UD LCD devices usually do not have local dimming function. Even for those with local dimming, they do not have enough backlight partitions (existing techniques provide 10 to 200 backlight partitions). Due to the limited number of backlight partitions, there are still defects for some special pictures. Some bright regions are not bright enough, and some dark regions are not dark enough. The contrast is therefore inferior, and viewing experience is compromised.

### SUMMARY OF THE INVENTION

An objective of the present invention is to provide a LCD device with a significantly increased number of backlight partitions to as to achieve fine adjustment to the backlight, thereby achieving better contrast, improved display effect, and enhanced display quality.

To achieve the objective, the present invention teaches a liquid crystal display (LCD) device, including a backlight module, a first LCD panel disposed on top of the backlight module, and a second LCD panel disposed on top of the first LCD panel.

The first LCD panel includes a first thin film transistor (TFT) substrate and a first liquid crystal layer disposed on top of the first TFT substrate. The first LCD panel divides light from the backlight module into n×m partitions, where n×m is the resolution of the first LCD panel.

The second LCD panel includes a second TFT substrate, a color filter (CF) substrate oppositely disposed to the second TFT substrate, and a second liquid crystal layer disposed between the second TFT substrate and the CF substrate.

The second LCD panel has a greater resolution than that of the first LCD panel.

The first LCD panel further includes a first lower polarization plate attached to a bottom side of the first TFT substrate, and a first upper polarization plate disposed on top of the first liquid crystal layer.

The second LCD panel further includes a second lower polarization plate attached to a bottom side of the second TFT substrate, and a second upper polarization plate disposed on top of the CF substrate.

The CF substrate includes at least red color resists, green color resists, and blue color resists.

The LCD device further includes a field programmable gate array (FPGA). The FPGA receives and processes a raw data signal, outputs a first data signal to the first LCD panel conforming to the resolution of the first LCD panel, and outputs a second data signal to the second LCD panel conforming to the resolution of the second LCD panel.

The FPGA outputs the first data signal to the first LCD panel and outputs the second data signal to the second LCD panel synchronously.

The first LCD panel has a first resolution 1920×1080, and the second LCD panel has a second resolution 3840×2160.

The raw data signal conforms to the second resolution 3840×2160. The first data signal output from the FPGA by compressing the raw data signal to the first LCD panel conforms to the first resolution 1920×1080.

The advantages of the present invention are as follow. The LCD device of the present invention disposes a first LCD panel and a second LCD panel on top of the backlight module. The first LCD panel divides the light from the backlight module into n×m partitions, where n×m is the first LCD panel. Therefore the number of backlight partitions is significantly increased. The first LCD panel does not have a CF substrate, and therefore the first LCD panel functions like a monoc screen, controlling the transmittance of each partition and providing fine adjustment to the backlight partition by partition. The backlight, after being adjusted partition-wise by the first LCD panel, is then incident into the second LCD panel for color display, thereby achieving better contrast, improved display effect, and enhanced display quality.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a perspective schematic diagram showing a conventional LCD device.

FIG. 2 is a perspective break-down diagram showing a LCD panel of the LCD device of FIG. 1.

FIG. 3 is a perspective schematic diagram showing a LCD device according to an embodiment of the present invention.

FIG. 4 is a perspective break-down diagram showing the LCD device of FIG. 3.

FIG. 5 is a schematic diagram showing a FPGA of the LCD device of FIG. 3 providing first and second data signals to the first and second LCD panels, respectively.

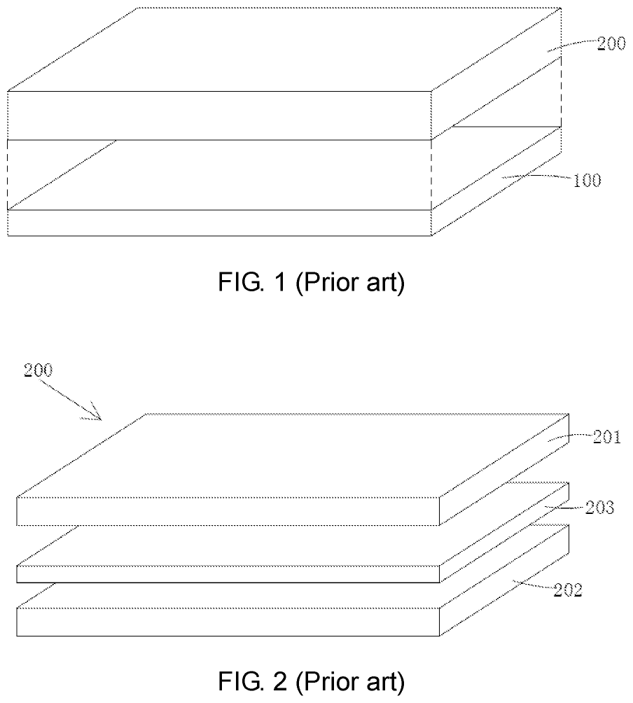

### DETAILED DESCRIPTION OF PREFERRED EMBODIMENTS

The following descriptions for the respective embodiments are specific embodiments capable of being implemented for illustrations of the present invention with referring to appended figures.

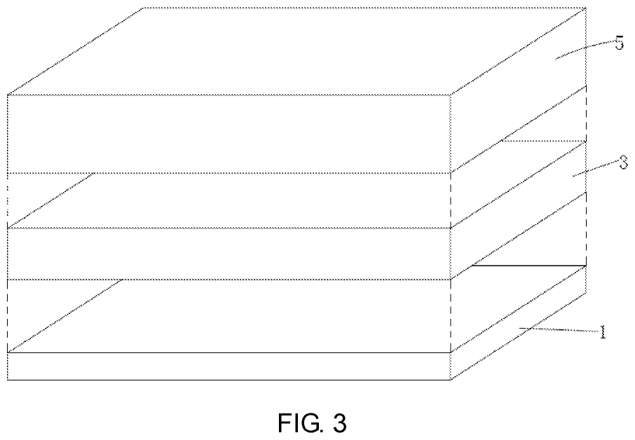

As shown in FIGS. 3 to 5, the present invention teaches a liquid crystal display (LCD) device.

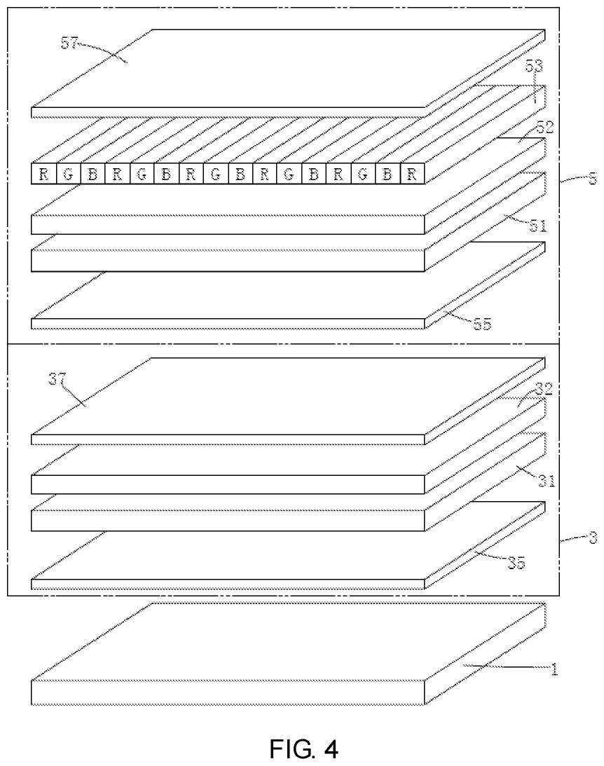

As shown in FIGS. 3 and 4, a LCD device according to an embodiment of present invention includes a backlight module 1, a first LCD panel 3 disposed on top of the backlight module 1, and a second LCD panel 5 disposed on top of the first LCD panel 3.

The backlight module 1 is for providing backlight.

Compared to typical LCD panels, the first LCD panel 3 is not configured with a color filter (CF) substrate, and includes only a first thin film transistor (TFT) substrate 31, a first liquid crystal layer 32 disposed on top of the first TFT substrate 31, a first lower polarization plate 35 attached to a bottom side of the first TFT substrate 31, and a first upper polarization plate 37 disposed on top of the first liquid crystal layer 32.

The second LCD panel 5 is a typical LCD panel, and includes a second TFT substrate 51, a CF substrate 53 oppositely disposed to the second TFT substrate 51, a second liquid crystal layer 52 disposed between the second TFT substrate 51 and the CF substrate 53, a second lower polarization plate 55 attached to a bottom side of the second TFT substrate 51, and a second upper polarization plate 57 disposed on top of the CF substrate 53. Furthermore, the CF substrate 53 includes at least red color resists R, green color resists G, and blue color resists B, so that light passing through the CF substrate 53 will have multiple colors.

As the first LCD panel 3 does not have a CF substrate, the first LCD panel 3 functions like a monoc screen, and controls only the transmittance of light. Therefore, the first LCD panel 3 is responsible for the brightness of the light from the backlight module 1. If the first LCD panel 3 has a resolution n×m (n, m are positive integers), the first LCD panel 3 divides the light from the backlight module 1 into n×m partitions. Furthermore, the first LCD panel 3 is preferably a full high definition (FHD) LCD panel with resolution 1920×1080 and without the CF substrate. The first LCD panel 3 therefore divides the light from the backlight module 1 into 1920×1080 partitions. There are as many as 2,073,600 partitions, which is 1000 times to the number of a conventional LCD panel's partitions. By controlling each partition's transmittance, the first LCD panel 3 is able to provide fine adjustment to the backlight. For example, if a part of a displayed image should be brighter, the transmittance of corresponding partitions of the first LCD panel 3 is increased; if another part of a displayed image should be darker, the transmittance of corresponding partitions of the first LCD panel 3 is decreased. As such, there is a sharp dark and bright difference, and the contrast is enhanced. The backlight, after being adjusted partition-wise by the first LCD panel 3, is then incident into the second LCD panel 5 for color display, thereby achieving better contrast, improved display effect, and enhanced display quality.

The second LCD panel 5 has a greater resolution than that of the first LCD panel 3. Preferably, the second LCD panel 5 is an ultra-high definition (UD) LCD panel with 3840×2160 resolution.

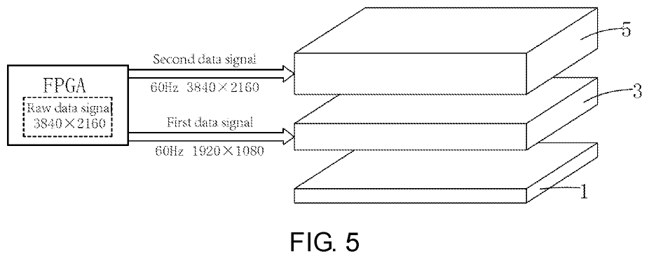

It should be noted that, to achieve the partition-wise backlight adjustment, not only the backlight from the backlight module has to be divided into fine partitions, but data signal for display on the LCD panel has to be processed in accordance with the backlight. As shown in FIG. 5, the LCD device of the present invention further includes a field programmable gate array (FPGA) that receives and processes raw data signal, and synchronously outputs first data signal to the first LCD panel 3 conforming to the resolution of the first LCD panel 3, and second data signal to the second LCD panel 5 conforming to the resolution of the second LCD panel 5. Preferably, the frequency of both the first and second data signal is 60 Hz.

If the first LCD panel 3 has a resolution 1920×1080 and the second LCD panel 5 has a resolution 3840×2160, the raw data signal should conform to the resolution 3840×2160. The FPGA, after processing the raw data signal, outputs to the second LCD panel 5 with the second data signal maintaining the original conformity to the resolution 3840×2160, and outputs to the first LCD panel 3 with the first data signal conforming to the resolution 1920×1080 by compressing the raw data signal.

As described above, the LCD device of the present invention disposes a first LCD panel and a second LCD panel on top of the backlight module. The first LCD panel divides the light from the backlight module into n×m partitions, where n×m is the first LCD panel. Therefore the number of backlight partitions is significantly increased. The first LCD panel does not have a CF substrate, and therefore the first LCD panel functions like a monoc screen, controlling the transmittance of each partition and providing fine adjustment to the backlight partition by partition. The backlight, after being adjusted partition-wise by the first LCD panel, is then incident into the second LCD panel for color display, thereby achieving better contrast, improved display effect, and enhanced display quality.

Above are embodiments of the present invention, which does not limit the scope of the present invention. Any equivalent amendments within the spirit and principles of the embodiment described above should be covered by the protected scope of the invention.

What is claimed is:

1. A liquid crystal display (LCD) device, comprising a backlight module, a first LCD panel disposed on top of the backlight module, and a second LCD panel disposed on top of the first LCD panel, wherein
the first LCD panel comprises a first thin film transistor (TFT) substrate and a first liquid crystal layer disposed on top of the first TFT substrate; the first LCD panel divides light from the backlight module into n×m partitions, where n×m is the resolution of the first LCD panel;
the second LCD panel comprises a second TFT substrate, a color filter (CF) substrate oppositely disposed to the second TFT substrate, and a second liquid crystal layer disposed between the second TFT substrate and the CF substrate; and
the second LCD panel has a greater resolution than that of the first LCD panel.

2. The LCD device according to claim 1, wherein the first LCD panel further comprises a first lower polarization plate attached to a bottom side of the first TFT substrate, and a first upper polarization plate disposed on top of the first liquid crystal layer.

3. The LCD device according to claim 1, wherein the second LCD panel further comprises a second lower polarization plate attached to a bottom side of the second TFT substrate, and a second upper polarization plate disposed on top of the CF substrate.

4. The LCD device according to claim 2, wherein the second LCD panel further comprises a second lower polarization plate attached to a bottom side of the second TFT substrate, and a second upper polarization plate disposed on top of the CF substrate.

5. The LCD device according to claim 1, wherein the CF substrate comprises at least red color resists, green color resists, and blue color resists.

6. The LCD device according to claim 1, further comprising a field programmable gate array (FPGA), wherein the FPGA receives and processes a raw data signal, outputs a first data signal to the first LCD panel conforming to the resolution of the first LCD panel, and outputs a second data signal to the second LCD panel conforming to the resolution of the second LCD panel.

7. The LCD device according to claim 6, wherein the FPGA outputs the first data signal to the first LCD panel and outputs the second data signal to the second LCD panel synchronously.

8. The LCD device according to claim 6, wherein the first LCD panel has a first resolution 1920×1080; and the second LCD panel has a second resolution 3840×2160.

9. The LCD device according to claim 8, wherein the raw data signal conforms to the second resolution 3840×2160; and the first data signal output from the FPGA by compressing the raw data signal to the first LCD panel conforms to the first resolution 1920×1080.
